(19) United States
(12) Patent Application Publication
(10) Pub. No.: US 2023/0357545 A1
(43) Pub. Date: Nov. 9, 2023

(54) METHOD FOR MAKING A COMPATIBILIZED BLEND FROM A BLEND OF POLYMERIC MATERIAL

(71) Applicant: Cryovac, LLC, Charlotte, NC (US)

(72) Inventors: Preeta Datta, Charlotte, NC (US); Drew Speer, Charlotte, NC (US)

(21) Appl. No.: 17/924,529

(22) PCT Filed: May 10, 2021
(86) PCT No.: PCT/US2021/031487

§ 371 Date: Nov. 10, 2022

Related U.S. Application Data
(60) Provisional application No. 63/023,478, filed on May 12, 2020.

(51) Int. Cl. C08L 23/06; C08J 3/12; C08J 3/20; C08J 3/00; C08J 5/18

(52) U.S. Cl. CPC C08L 23/06; C08J 3/12; C08J 3/201; C08J 3/005; C08J 5/18; C08J 2300/30; C08J 2400/30; C08J 2323/06; C08J 2477/00; C08J 2423/08; C08J 2429/04; C08J 2423/10; C08J 2451/08; C08J 2453/00

(57) ABSTRACT

A method for making polymeric pellets and films therefrom is disclosed. The polymeric pellets and films include a mixture of at least three distinct polymeric materials along with a compatibilizer and a rheology modifier.

### CROSS-REFERENCE TO RELATED APPLICATIONS

This application claims priority to U.S. Patent Application Ser. No. 63/023,478, filed May 12, 2020 and entitled “Method for Making a Compatibilized Blend From a Blend of Polymeric Material,” the entirety of which is incorporated herein by reference.

### BACKGROUND

The subject matter disclosed herein relates to the field of polymeric material. More particularly, to a method for making pellets and films from distinct polymeric materials.

Most polymers are immiscible with other types of polymers. The incompatibility of different polymers hinders the properties and performance of blends. Compatibilizers are often used as additives to improve the compatibility of immiscible polymers and thus improve the morphology and resulting properties of the blend.

When mixing two polymers that would form an immiscible polymer blend, a copolymer is often used as a compatibilizer. The copolymer is made of the two components in the immiscible polymer blend. For example, ethylene/propylene copolymers are used as compatibilizers for blends of polypropylene and polyethylene. However, as polymer blends become more complex and include additional polymers, a single compatibilizer will not solve its intended purpose.

Therefore, additives to improve the mixability and compatibility of a wider range of immiscible polymers is desired.

The discussion above is merely provided for general background information and is not intended to be used as an aid in determining the scope of the claimed subject matter.

### BRIEF DESCRIPTION

A method for making polymeric pellets and films therefrom is disclosed. The polymeric pellets and films include a mixture of at least three distinct polymeric materials along with a compatibilizer and a rheology modifier.

An advantage that may be realized in the practice of some disclosed embodiments is the ability to mix and compatibilized a wide range of normally immiscible polymers.

In one exemplary embodiment, a method for forming polymeric pellets is disclosed. The method comprises heating a blended polymer mixture comprising a polyolefin, polyamide, an anhydride grafted polymer and polypropylene to the melting or glass transition temperature of the polymers included in the blended polymer mixture to form a polymer blend. Mixing a compatibilizer and a rheology modifier with the polymer blend to form a polymeric mixture. Cooling the polymeric mixture to form a solidified polymeric mixture. Pelletizing the solidified polymeric mixture to form polymeric pellets. The polymeric pellets comprising a polyolefin, polyamide, an anhydride grafted polymer, polypropylene a compatibilizer and a rheology modifier.

In another exemplary embodiment, the method comprises forming a film comprising the steps of heating blended polymer mixture comprising a polyolefin, polyamide, an anhydride grafted polymer and polypropylene to the melting or glass transition temperature of the polymer materials to form a polymer blend. Mixing a compatibilizer and a rheology modifier with the polymer blend to form a polymeric mixture. Cooling the polymeric mixture to form a solidified polymeric mixture. Pelletizing the solidified polymeric mixture to form polymeric pellets. Heating and extruding the polymeric pellets to form at least one layer of film.

In another exemplary embodiment, a polymeric pellet is disclosed. The polymeric pellet comprises a polyolefin; a polyamide; an anhydride grafted polymer; a polypropylene; a compatibilizer; and a rheology modifier.

In another exemplary embodiment, a multilayer film comprising at least one layer comprising is disclosed. The multilayer film comprising at least one layer comprising comprises a polyolefin; a polyamide; an anhydride grafted polymer; a polypropylene; a compatibilizer; and a rheology modifier.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. In the drawings, like numerals are used to indicate like parts throughout the various views. Thus, for further understanding of the invention, reference can be made to the following detailed description, read in connection with the drawings in which:

FIG. 1 is a chart showing the rheology of various films;

FIG. 2 is a microscopic comparison of nylon domains in a control compared to a blend described herein;

FIG. 3 is a schematic of a process used to make a heat-shrinkable film such as could be used to make a heat-shrinkable film; and

FIG. 4 is a schematic of a process used to make a non-heat-shrinkable film.

### DETAILED DESCRIPTION

As used herein, the term “film” is inclusive of plastic web, regardless of whether it is film or sheet. The film can have a thickness of 0.25 mm or less, or a thickness of from 0.5 to 30 mils, or from 0.5 to 15 mils, or from 1 to 10 mils, or from 1 to 8 mils, or from 1.1 to 7 mils, or from 1.2 to 6 mils, or from 1.3 to 5 mils, or from 1.5 to 4 mils, or from 1.6 to 3.5 mils, or from 1.8 to 3.3 mils, or from 2 to 3 mils, or from 1.5 to 4 mils, or from 0.5 to 1.5 mils, or from 1 to 1.5 mils, or from 0.7 to 1.3 mils, or from 0.8 to 1.2 mils, or from 0.9 to 1.1 mils.

The multi-layer films described herein may comprise at least, and/or at most, any of the following numbers of layers: 2, 3, 4, 5, 6, 7, 8, 9, 10, 11, 12, 13, 14 and 15. As used herein, the term “layer” refers to a discrete film component which is substantially coextensive with the film and has a substantially uniform composition. Where two or more directly adjacent layers have essentially the same composition, then these two or more adjacent layers may be considered a single layer for the purposes of this application. In an embodiment, the multilayer film utilizes microlayers. A microlayer section may include between 10 and 1,000 microlayers in each microlayer section.

The ability to recycling and reusing polymers is a way to reduce costs and divert materials from landfills. However, when reusing a blended polymer mixture, including reclaimed polymer material that contains a blend of immiscible polymers, processing challenges are evident. As used herein, “blended polymer mixture” means polymer material containing at least three distinct polymers selected from ethylene/alpha-olefin copolymers, polyamides, polypropylene, ethylene vinyl alcohol and ethylene vinyl acetate. In an embodiment, the blended polymer mixture includes at least one ethylene/alpha-olefin copolymer, at least one polyamide, and at least one polypropylene. Such polymers are immiscible with each other. Reclaimed polymer material can include, but is not limited to cut scraps; trimmed materials; transition materials; off spec material; start up, shut down or flush material, post-industrial and post-consumer recycled materials. Due to the nature of obtaining scrap material and reclaimed polymer material, the exact composition of blends may vary from batch to batch. As streams becoming more standardized, variation from batch to batch may become less variable.

As used herein, the term “polyolefin” refers to olefin polymers and copolymers, especially ethylene and propylene polymers and copolymers, and to polymeric materials having at least one olefinic comonomer. Polyolefins can be linear, branched, cyclic, aliphatic, aromatic, substituted, or unsubstituted. Included in the term polyolefin are homopolymers of olefin, copolymers of olefin, copolymers of an olefin and a non-olefinic comonomer copolymerizable with the olefin, such as vinyl monomers, modified polymers of the foregoing, and the like. Modified polyolefins include modified polymers prepared by copolymerizing the homopolymer of the olefin or copolymer thereof with an unsaturated carboxylic acid, e.g., maleic acid, fumaric acid or the like, or a derivative thereof such as the anhydride, ester metal salt or the like. It could also be obtained by incorporating into the olefin homopolymer or copolymer, an unsaturated carboxylic acid, e.g., maleic acid, fumaric acid or the like, or a derivative thereof such as the anhydride, ester metal salt or the like. In an embodiment, the heat seal layer is mainly composed of polyolefin. In an embodiment, the heat seal layer has a total polyolefin content of from 90 to 99 wt % based on the total composition of the heat seal layer.

Ethylene homopolymer or copolymer refers to ethylene homopolymer such as low density polyethylene; ethylene/alpha olefin copolymer such as those defined hereinbelow; and other ethylene copolymers such as ethylene/vinyl acetate copolymer; ethylene/alkyl acrylate copolymer; or ethylene/(meth)acrylic acid copolymer. Ethylene/alpha-olefin copolymer herein refers to copolymers of ethylene with one or more comonomers selected from C3 to C20, C4 to C10 or C4 to C8 alpha-olefins such as butene-1, hexene-1, octene-1, etc. in which the molecules of the copolymers comprise long polymer chains with relatively few side chain branches arising from the alpha-olefin which was reacted with ethylene. This molecular structure is to be contrasted with conventional high pressure low or medium density polyethylenes which are highly branched with respect to ethylene/alpha-olefin copolymers and which high pressure polyethylenes contain both long chain and short chain branches. Ethylene/alpha-olefin copolymers include one or more of the following: 1) high density polyethylene, for example having a density greater than 0.94 g/cm³, 2) medium density polyethylene, for example having a density of from 0.93 to 0.94 g/cm³, 3) linear medium density polyethylene, for example having a density of from 0.926 to 0.94 g g/cm³, 4) low density polyethylene, for example having a density of from 0.915 to 0.939 g/cm³, 5) linear low density polyethylene, for example having a density of from 0.915 to 0.935 g/cm³, 6) very-low or ultra-low density polyethylene, for example having density below 0.915 g/cm³, and homogeneous ethylene/alpha-olefin copolymers. Homogeneous ethylene/alpha-olefin copolymers include those having a density of less than about any of the following: 0.925, 0.922, 0.92, 0.917, 0.915, 0.912, 0.91, 0.907, 0.905, 0.903, 0.90, and 0.86 g/cm³. Unless otherwise indicated, all densities herein are measured according to ASTM D-1505.

“Polyamide” herein refers to polymers having amide linkages along the molecular chain, and preferably to synthetic polyamides such as nylons. Furthermore, such term encompasses both polymers comprising repeating units derived from monomers, such as caprolactam, which polymerize to form a polyamide, as well as polymers of diamines and diacids, and copolymers of two or more amide monomers, including nylon terpolymers, sometimes referred to in the art as “copolyamides”. Useful polyamides include those of the type that may be formed by the polycondensation of one or more diamines with one or more diacids and/or of the type that may be formed by the polycondensation of one or more amino acids. Useful polyamides include aliphatic polyamides and aliphatic/aromatic polyamides.

Representative aliphatic diamines for making polyamides include those having the formula:

H₂N(CH₂)ₙNH₂
where n has an integer value of 1 to 16. Representative examples include trimethylenediamine, tetramethylenediamine, pentamethylenediamine, hexamethylenediamine, octamethylenediamine, decamethylenediamine, dodecamethylenediamine, hexadecamethylenediamine. Representative aromatic diamines include p-phenylenediamine, 4,4′-diaminodiphenyl ether, 4,4′ diaminodiphenyl sulphone, 4,4′-diaminodiphenylethane. Representative alkylated diamines include 2,2-dimethylpentamethylenediamine, 2,2,4- trimethylhexamethylenediamine, and 2,4,4 trimethylpentamethylenediamine. Representative cycloaliphatic diamines include diaminodicyclohexylmethane. Other useful diamines include heptamethylenediamine, nonamethylenediamine, and the like.

Representative diacids for making polyamides include dicarboxylic acids, which may be represented by the general formula:

HOOC—Z—COOH
where Z is representative of a divalent aliphatic radical containing at least 2 carbon atoms. Representative examples include adipic acid (i.e., hexanedioic acid), sebacic acid, octadecanedioic acid, pimelic acid, suberic acid, azelaic acid, dodecanedioic acid, and glutaric acid. The dicarboxylic acids may be aliphatic acids, or aromatic acids such as isophthalic acid and terephthalic acid.

The polycondensation reaction product of one or more or the above diamines with one or more of the above diacids may form useful polyamides. Representative polyamides of the type that may be formed by the polycondensation of one or more diamines with one or more diacids include aliphatic polyamides such as poly(hexamethylene adipamide) (“nylon-6,6”), poly(hexamethylene sebacamide) (“nylon-6,10”), poly(heptamethylene pimelamide) (“nylon-7,7”), poly(octamethylene suberamide) (“nylon-8,8”), poly(hexamethylene azelamide) (“nylon-6,9”), poly(nonamethylene azelamide) (“nylon-9,9”), poly(decamethylene azelamide) (“nylon-10,9”), poly(tetramethylenediamine-co-oxalic acid) (“nylon-4,2”), the polyamide of n-dodecanedioic acid and hexamethylenediamine (“nylon-6,12”), the polyamide of dodecamethylenediamine and n-dodecanedioic acid (“nylon-12,12”).

Representative aliphatic/aromatic polyamides include poly(tetramethylenediamine-co-isophthalic acid) (“nylon-4,I”), polyhexamethylene isophthalamide (“nylon-6,I”), poly (2,2,2-trimethyl hexamethylene terephthalamide), poly(m-xylylene adipamide) (“nylon-MXD,6”), poly(p-xylylene adipamide), poly(hexamethylene terephthalamide), poly(dodecamethylene terephthalamide), and polyamide-MXD,I.

Representative polyamides of the type that may be formed by the polycondensation of one or more amino acids include poly(4-aminobutyric acid) (“nylon-4”), poly(-aminohexanoic acid) (“nylon-6” or “poly(caprolactam)”), poly(7-aminoheptanoic acid) (“nylon-7”), poly(-aminooctanoic acid) (“nylon-8”), poly(9-aminononanoic acid) (“nylon-9”), poly(10-aminodecanoic acid) (“nylon-10”), poly(11-aminoundecanoic acid) (“nylon-11”), and poly(12-aminododecanoic acid) (“nylon-12”).

Representative copolyamides include copolymers based on a combination of the monomers used to make any of the foregoing polyamides, such as, nylon-4/6, nylon-6/9, caprolactam/hexamethylene adipamide copolymer (“nylon-6,6/6”), hexamethylene adipamide/caprolactam copolymer (“nylon-6/6,6”), trimethylene adipamide/hexamethylene azelaiamide copolymer (“nylon-trimethyl 6,2/6,2”), hexamethylene adipamide-hexamethylene-azelaiamide caprolactam copolymer (“nylon-6,6/6,9/6”), hexamethylene adipamide/hexamethylene-isophthalamide (“nylon-6,6/6,I”), hexamethylene adipamide/hexamethyleneterephthalamide (“nylon-6,6/6,T”), nylon-6,T/6,I, nylon-6/MXD,T/MXD,I, nylon-6,6/6,10, and nylon-6,I/6,T.

Polyamides also include modifications and blends of those discussed above. “Polyamide” further includes amorphous, crystalline or partially crystalline, aromatic or partially aromatic polyamides.

Ethylene vinyl alcohol is a copolymer consisting essentially of ethylene and vinyl alcohol recurring structural units and can contain small amounts of other monomer units, in particular of vinyl ester units. These copolymers can be prepared by saponification or partial or complete alcoholysis of ethylene-vinyl ester copolymers. Among such vinyl esters, vinyl acetate is the preferred monomer. The degree of saponification or of alcoholysis is at least 90 mol % and can range from 94% to 99.5%. In some embodiments, the molar proportion of ethylene in the ethylene vinyl alcohol can range from 3 mol % to 75 mol %; in some embodiments, from 10 mol % to 50 mol %; in some embodiments, between about 24 mol % and about 52 mol %; and in some embodiments, from about 28 mol % to about 48 mol %. However, greater or lesser amounts of ethylene content are also envisioned and can be included within the scope of the presently disclosed subject matter.

Ethylene vinyl acetate is a copolymer of ethylene and vinyl acetate. The vinyl acetate monomer unit can be represented by the general formula:

[CH₃COOCH═CH₂]

In an embodiment the ethylene vinyl acetate copolymers have a vinyl acetate content from 4 wt % to 28 wt %. In another embodiment, the ethylene vinyl acetate copolymers have a vinyl acetate content from 9 wt % to 18 wt %.

In use, the mix of polymers described herein is melted and mixed to form a polymer blend. For larger pieces, material may be cut or pre-ground into smaller pieces to aid in the melting process. In an embodiment the polymer blend includes at least three immiscible polymers. In an embodiment, the polymer blend includes at least three immiscible polymers selected from ethylene/alpha-olefin copolymers, polyamides, polypropylene, ethylene vinyl alcohol and ethylene vinyl acetate. In an embodiment, the polymer blend includes at least four immiscible polymers selected from ethylene/alpha-olefin copolymers, polyamides, polypropylene, ethylene vinyl alcohol and ethylene vinyl acetate. In an embodiment, the polymer blend includes ethylene/alpha-olefin copolymers, polyamides, polypropylene, ethylene vinyl alcohol and ethylene vinyl acetate. In an embodiment, the polymer blend includes at least one ethylene/alpha-olefin copolymer, at least one polyamide, and at least one polypropylene.

In embodiments, the polymer blend includes ethylene/alpha-olefin copolymer content in an amount of 5 -50 wt %, 10-50 wt %, 15-50 wt %, 20-50 wt %, 25-45 wt %, 30-45 wt % or 35-45 wt %. In embodiments, the polymer blend includes polyamide content in an amount of 5 -50 wt %, 10-50 wt %, 15-50 wt %, 20-50 wt %, 25-45 wt %, 30-45 wt % or 35-45 wt %. In embodiments, the polymer blend includes polypropylene content in an amount of 5 -50 wt %, 10-50 wt %, 15-45 wt %, 20-45 wt %, 20-40 wt %, or 25-35 wt %. In embodiments, the polymer blend includes anhydride grafted polyethylene, anhydride grafted polypropylene or blends thereof are present in an amount of 1-50 wt %, 5-40 wt %, 10-30 wt %, 10-25 wt %, or 15-25 wt %. In embodiments, the polymer blend includes ethylene homopolymer content in an amount of 5 -50 wt %, 10-50 wt %, 15-50 wt %, 20-50 wt %, 25-45 wt %, 30-45 wt % or 35-45 wt %. In embodiments, the polymer blend includes ethylene copolymer content in an amount of 5 -50 wt %, 10-50 wt %, 15-50 wt %, 20-50 wt %, 25-45 wt %, 30-45 wt % or 35-45 wt %. In embodiments, the polymer blend includes ethylene/propylene copolymer content in an amount of 5 -50 wt %, 10-50 wt %, 15-50 wt %, 20-50 wt %, 25-45 wt %, 30-45 wt % or 35-45 wt %. In embodiments, the polymer blend includes propylene/butene copolymer content in an amount of 5 -50 wt %, 10-50 wt %, 15-50 wt %, 20-50 wt %, 25-45 wt %, 30-45 wt % or 35-45 wt %. In embodiments, the polymer blend includes ionomer content in an amount of 5 -50 wt %, 10-50 wt %, 15-50 wt %, 20-50 wt %, 25-45 wt %, 30-45 wt % or 35-45 wt %. In embodiments, the polymer blend includes ethylene vinyl alcohol content in an amount of 5-25 wt %, 10-25 wt %, 15-25 wt %, 20-25 wt %, or less than 25 wt %. In embodiments, the polymer blend includes less than 70%, 60%, 50% or 40% polyolefins. In embodiments, the polymer blend includes less than any of the following amounts of ethylene vinyl acetate 1 wt %, 2 wt %, 3 wt %, 4 wt %, 5 wt %, 6 wt %, 7 wt %, 8 wt %, 9 wt % or 10 wt %.

The polymeric mixture includes a blend of blend of polymeric materials, including an ethylene/alpha-olefin copolymer, polyamide and polypropylene, anhydride grafted polyethylene or anhydride grafted polypropylene, a compatibilizer and a rheology modifier. In some embodiments, the blend of polymeric materials further includes ethylene homopolymers, ethylene copolymers, ethylene/propylene copolymers, propylene/butene copolymers, ionomers and blends thereof. In an embodiment, the polymeric mixture further includes ethylene vinyl alcohol and/or ethylene vinyl acetate. In embodiments, the polymeric mixture may further include up to 50% virgin polymeric material. In an embodiment the polymeric mixture includes a polyamide selected from nylon 6, nylon 6/66, and amorphous nylons.

In an embodiment, ethylene/alpha-olefin copolymer is present in the polymeric mixture in an amount of at less than 5 wt %, 10 wt %, 15 wt %, 20 wt %, 25 wt %, 30 wt %, 35 wt %, 40 wt %, 45 wt % or 50 wt % as compared to the total weight of the polymeric mixture. In an embodiment, ethylene/alpha-olefin copolymer is present in the polymeric mixture in an amount of between 5 wt % and 40 wt %. In an embodiment, the ethylene/alpha-olefin copolymer is a high density polyethylene, medium density polyethylene, linear medium density polyethylene, low density polyethylene, linear low density polyethylene, a very-low or ultra-low density polyethylene, or blend thereof.

In an embodiment, polyamide is present in the polymeric mixture in an amount of at less than 5 wt %, 10 wt %, 15 wt %, 20 wt %, 25 wt %, 30 wt %, 35 wt %, 40 wt %, 45 wt % or 50 wt % as compared to the total weight of the polymeric mixture. In an embodiment, polyamide is present in the polymeric mixture in an amount of between 5 wt % and 40 wt %.

In an embodiment, polyamide is present in the polymeric mixture in an amount of between 20 wt % and 35 wt %. In embodiments within the above ranges, the polyamide is selected from nylon 6, nylon 6/66, amorphous nylons and blends thereof.

In an embodiment, polypropylene or copolymers thereof are present in the polymeric mixture in an amount of at less than 5 wt %, 10 wt %, 15 wt %, 20 wt %, 25 wt %, 30 wt %, 35 wt %, 40 wt %, 45 wt % or 50 wt % as compared to the total weight of the polymeric mixture. In an embodiment, polypropylene is present in the polymeric mixture in an amount of between 1 wt % and 30 wt %. In an embodiment, polypropylene is present in the polymeric mixture in an amount of between 5 wt % and 15 wt %.

In an embodiment, ethylene vinyl alcohol is present in the polymeric mixture in an amount of at less than 5 wt %, 10 wt %, 15 wt %, 20 wt % or 25 wt % as compared to the total weight of the polymeric mixture. In an embodiment, ethylene vinyl alcohol is present in the polymeric mixture in an amount of between 1 wt % and 20 wt %. In an embodiment, ethylene vinyl alcohol is present in the polymeric mixture in an amount of between 5 wt % and 15 wt %. In embodiments, the ethylene vinyl alcohol has an ethylene content of from about 34 to 60 weight percent.

In an embodiment, ethylene vinyl acetate is present in the polymeric mixture in an amount of at less than 1 wt %, 2 wt %, 3 wt %, 4 wt %, 5 wt %, 6 wt %, 7 wt %, 8 wt %, 9 wt % or wt % as compared to the total weight of the polymeric mixture. In embodiments, the ethylene vinyl acetate copolymer has a vinyl acetate content of at least about, and/or at most 10 about, any of the following weight % amounts: 3%, 5%, 10%, 15%, 20%, 22%, 24%, 25%, 28%, and 30%. ethylene vinyl acetate also includes, for example, ethylene/vinyl acetate/carbon monoxide terpolymer, for example, having carbon monoxide content of at least about, and/or at most about, any of the following weight % amounts: 0.1%, 0.5%, 1%, 1.5%, 2%, 3%, 4%, and 5%, all based on the weight of the polymer.

In an embodiment, anhydride grafted polyethylene, anhydride grafted polypropylene or blends thereof are present in the polymeric mixture in an amount of at less than 5 wt %, 10 wt %, 15 wt %, 20 wt %, 25 wt %, 30 wt %, 35 wt %, 40 wt %, 45 wt % or 50 wt % as compared to the total weight of the polymeric mixture. In an embodiment, anhydride grafted polyethylene, anhydride grafted polypropylene or blends thereof are present in the polymeric mixture in an amount of between 5 wt % and 40 wt %. In an embodiment, anhydride grafted polyethylene, anhydride grafted polypropylene or blends thereof are present in the polymeric mixture in an amount of between 10 wt % and 20 wt %. In an embodiment, anhydride grafted polyethylene, anhydride grafted polypropylene or blends thereof are malic anhydride grafted polyethylene, malic anhydride grafted polypropylene or blend thereof present in the polymeric mixture in an amount of between 10 wt % and 20 wt %. The anhydride grafted polyethylene, anhydride grafted polypropylene do provide some levels of compatibilization when included in a polymeric blend of polar polymers with polyolefins. However, the level of compatibilization is inadequate to obtain a suitable blend for further processing. In addition, as demonstrated in the examples below, adding additional anhydride grafted polymer to the blend actually produces worse results. The additional anhydride grafted polymer causes globing within the blend, thereby hindering further processing and mixability of the blend.

In an embodiment, ethylene homopolymers are present in the polymeric mixture in an amount of at less than 5 wt %, 10 wt %, 15 wt %, 20 wt %, 25 wt %, 30 wt %, 35 wt %, 40 wt %, 45 wt % or 50 wt % as compared to the total weight of the polymeric mixture. In an embodiment, ethylene homopolymers are present in the polymeric mixture in an amount of between 5 wt % and 40 wt %. In an embodiment, ethylene homopolymers are present in the polymeric mixture in an amount of between 20 wt % and 40 wt %.

In an embodiment, ethylene copolymers are present in the polymeric mixture in an amount of at less than 5 wt %, 10 wt %, 15 wt %, 20 wt %, 25 wt %, 30 wt %, 35 wt %, 40 wt %, 45 wt % or 50 wt % as compared to the total weight of the polymeric mixture. In an embodiment, ethylene copolymers are present in the polymeric mixture in an amount of between 5 wt % and 40 wt %. In an embodiment, ethylene copolymers are present in the polymeric mixture in an amount of between 20 wt % and 40 wt %. In embodiments, the ethylene copolymer is an ethylene/alpha-olefin copolymer. In an embodiment, the ethylene copolymer is a linear low density polyethylene, very low density polyethylene or blend thereof.

In an embodiment, ethylene/propylene copolymers are present in the polymeric mixture in an amount of at less than 5 wt %, 10 wt %, 15 wt %, 20 wt %, 25 wt %, 30 wt %, 35 wt %, 40 wt %, 45 wt % or 50 wt % as compared to the total weight of the polymeric mixture. In an embodiment, ethylene/propylene copolymers are present in the polymeric mixture in an amount of between 5 wt % and 40 wt %. In embodiments the ethylene content of the ethylene/propylene copolymers is between 3-5 wt %.

In an embodiment, propylene/butene copolymers are present in the polymeric mixture in an amount of at less than 5 wt %, 10 wt %, 15 wt %, 20 wt %, 25 wt %, 30 wt %, 35 wt %, 40 wt %, 45 wt % or 50 wt % as compared to the total weight of the polymeric mixture. In an embodiment, propylene/butene copolymers are present in the polymeric mixture in an amount of between 5 wt % and 40 wt %. In an embodiment, propylene/butene copolymers are present in the polymeric mixture in an amount of between 20 wt % and 40 wt %.

In an embodiment, ionomers are present in the polymeric mixture in an amount of at less than 5 wt %, 10 wt %, 15 wt %, 20 wt %, 25 wt %, 30 wt %, 35 wt %, 40 wt %, 45 wt % or 50 wt % as compared to the total weight of the polymeric mixture. In an embodiment, ionomers are present in the polymeric mixture in an amount of between 5 wt % and 40 wt %. In an embodiment, ionomers are present in the polymeric mixture in an amount of between 20 wt % and 40 wt %.

Since many polymers are immiscible with each other, adding a compatibilizer can aid in creating a processable blend with improved mechanical properties. A compatibilizer in the context of the present disclosure is a polymeric additive that stabilizes the morphology by enhancing interphase adhesion in the polymer blend. A compatibilizer is any compound that functions to enhance interphase adhesion of the interface between blended immiscible polymers. In an embodiment, the compatibilizer is polypropylene/polyethylene copolymer. In another embodiment, the compatibilizer is a block polypropylene/polyethylene copolymer such as those commercially available under the tradenames Intune™ available from Dow or Vistamaxx™ from Exxon. The compatibilizer is present in the polymeric mixture in an amount between 1 and 10 wt %. In an embodiment the compatibilizer is present in the polymeric mixture at no more than 10 wt %.

The polymeric mixture further includes a rheology modifier. The rheology modifier aides in the processability and further aids in the compatibility of the polymeric mixture without the need for being a block copolymer of other polymers in the mixture. In an embodiment, the rheology modifier is a low molecular weight ethylene acrylic acid copolymer or low molecular weight ethylene-methacrylic-acid-copolymer. In embodiments, the ethylene acrylic acid has an acrylic acid content of between 5 and 20 wt %. As used herein, low molecular weight means having a molecular weight of less than 10,000 g/mol. Selection of a rheology modifier having a particular molecular weight can modify the viscosity and flow properties of the blend. In addition, selection of a rheology modifier having beneficial polar and/or hydrogen bonding properties will aid in creating a more homogenous blend. In embodiments, the homogenous blend is achieved primarily by the polarity of the hydrogen bonding. Little, if any reactive properties of the additives are required. The rheology modifier is present in the polymeric mixture in an amount between 1 and 10 wt %. In an embodiment the rheology modifier is present in the polymeric mixture at no more than 10 wt %.

In an embodiment the polymeric mixture further includes between 0.05 to 3 wt % of an antioxidant. An antioxidant, as defined herein, is any material which inhibits oxidative degradation or cross-linking of polymers. Examples of antioxidants suitable for use are, for example, hindered phenolics, such as, 2,6-di(t-butyl)4-methyl-phenol(BHT), 2,2″-methylene-bis(6-t-butyl-p-cresol); phosphites, such as, triphenylphosphite, tris-(nonylphenyl)phosphite; thiols, such as, dilaurylthiodipropionate; pentaerythritol tetrakis(3-(3,5-di-tert-butyl-4-hydroxyphenyl)propionate); octadecyl 3-(3,5-di-tert-butyl-4-hydroxyphenyl)propionate and the like.

The polymeric mixture can be prepared by mixing the polymers, the compatibilizer, the rheology modifier, an antioxidant (which may be part of a masterbatch) and any additional additives in any appropriate apparatus. Typically, the polymeric mixture is mixed together, heated to melting and stirred to homogeneity, and the homogeneous melt is then extruded. The extruded melt is then typically cooled and pelletized to form pellets of the polymeric mixture. However, other forms, such as a powder, are possible. Other techniques of preparing the polymeric mixture may be apparent to one of ordinary skill in the art.

To aid mixing, the blending step includes the blending of a compatibilizer and rheology modifier. The blending can be integrated into the manufacturing process or forming step of a film or layer of a multilayer film as the feed material.

After being made, the polymeric mixture can be stored for a period of time from days to years, or it can be made as part of a method of forming a film layer as described below. In such a method, the blended composition is fed from the extruder or other blending apparatus directly into further steps of the method

The process of forming pellets includes the following steps: (i) melting (in the case of amorphous material, heating to above the glass transition temperature) a blend of polymers which optionally include reclaimed polymers to form a polymer blend melt; (ii) optionally filtering the polymer blend melt via physical filtering and/or via vented extruder; (iii) extruding the melt through a die to form a substantially continuous molten polymer extrudate; (iv) cooling the molten extrudate to form a cooled extrudate; and (v) pelletizing the cooled extrudate to form a plurality of polymer pellets. In embodiments, the cooling and pelletizing steps are performed via a single instrument such as by die face pelletizing, wherein the extrudate is cut in a stream of cooling fluid (such as water).

The polymer blend can be melted and extruded in any type of extruder known in the art, such as a single screw extruder, a twin-screw extruder, and a ram extruder. Extruders may also be used in series with mixers, if desired. Additives are added to the polymer matrix by addition to the extruder and/or mixer.

The die may be any type of die or form known in the art, such as a multi-orifice die through which strands of extrudate are conveyed. The shape of the orifices may take any known shape, such as circular, oval, and square. In embodiments, circular dies are utilized since they form an extrudate that are substantially cylindrical in configuration. The cylindrical extrudate often leads to cylindrical pellets. A cylindrical configuration reduces the likelihood of pellet agglomeration.

In embodiments, the molten extrudate may be cooled by extrusion into a water bath and pelletized. The water bath is maintained at a temperature substantially lower than that of the molten extrudate. In embodiments, the temperature of the water bath substantially corresponds to the maximum crystallization temperature of the thermoplastic polymer. Maximizing the level of crystallinity at the surfaces of the pellets will render the surfaces less tacky such that the likelihood of agglomeration is reduced.

The cooled extrudate may be pelletized to form pellets according to any methods known in the art. Any pelletizer designed for pelletizing polymer strands is suitable for use in the present invention. Pelletizers are well known in the art and are widely available commercially from many sources. The most common types of pelletizers fall under the following categories: underwater pelletizers, water ring pelletizers and strand pelletizers. In embodiments the pelletizer will includes a cutting device, such as a flying wheel. In embodiments the pelletization takes place within the water bath. Underwater pelletization is disclosed, for example, in U.S. Pat. No. 7,163,989. The pellets can then be dried by any method known in the art, including, but not limited to a cyclone drier or heater.

The entire polymeric mixture of the pellet is intended to flow to allow for processing. In an embodiment the polymeric mixture has a composite melt index of from 0.5 to 5 g/10 min @190° C. and 2.16 kg measured in accordance with ASTM D1238. In an embodiment the polymeric mixture has a composite melt index of from 1 to 5 g/10 min @190° C. and 2.16 kg measured in accordance with ASTM D1238. In an embodiment the polymeric mixture has a composite melt index of from 3 to 4 g/10 min @190° C. and 2.16 kg measured in accordance with ASTM D1238.

The pellets can be melted and extruded to form film structures. Single layer or monolayer film structures can be prepared by solvent casting, injection molding, blow molding, stretch blow molding, or by extrusion, among other techniques. Multiple layer film structures are typically prepared using coextrusion, injection molding, blow molding, stretch blow molding, coating, or lamination, among other techniques.

Suitable methods include cast coextrusion, such as that disclosed in U.S. Pat. No. 4,551,380 to Schoenberg, herein incorporated by reference in its entirety, tubular or flat cast extrusion, blown bubble extrusion (for monolayer films) or coextrusion (for multilayer films), and by techniques well known in the art.

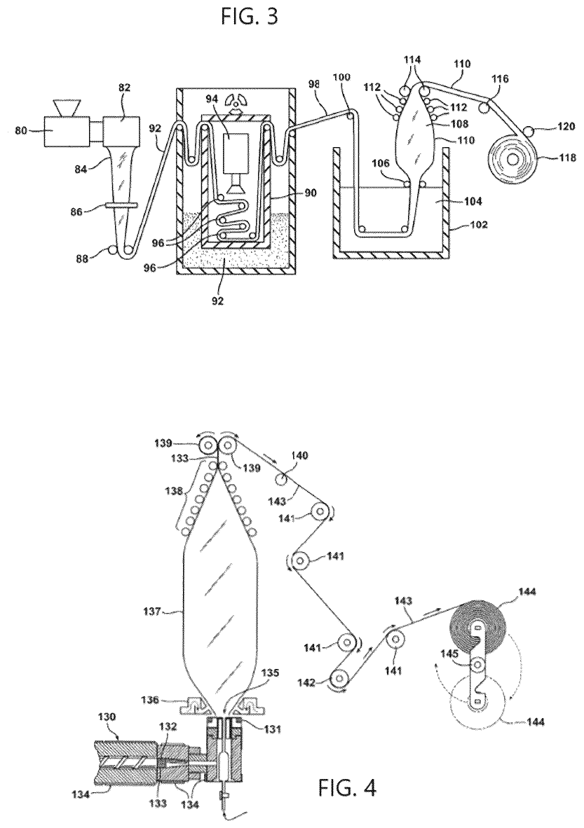

For example, FIG. 3 is a schematic of a process used to make a heat-shrinkable film such as could be used to make a heat-shrinkable bag. The process of FIG. 3 utilizes solid state orientation to produce polymer stress at a temperature below the melting point, whereby the resulting oriented film is heat shrinkable. In the process illustrated in FIG. 3, solid polymer beads (not illustrated) are fed to a plurality of extruders 80 (for simplicity, only one extruder is illustrated). Inside extruders 80, the polymer beads are forwarded, melted, and degassed, following which the resulting bubble-free melt is forwarded into die head 82, and extruded through annular die, resulting in tubing 84 which is 5-40 mils thick, more preferably 20-30 mils thick, still more preferably, about 25 mils thick.

After cooling or quenching by water spray from cooling ring 86, tubing 84 is collapsed by pinch rolls 88, and is thereafter fed through irradiation vault 90 surrounded by shielding 92, where tubing 84 is irradiated with high energy electrons (i.e., ionizing radiation) from iron core transformer accelerator 94. Tubing 84 is guided through irradiation vault 90 on rolls 96. Preferably, the irradiation of tubing 84 is at a level of about 7 MR.

After irradiation, irradiated tubing 98 is directed over guide roll 100, after which irradiated tubing 98 passes into hot water bath tank 102 containing water 104. The now collapsed irradiated tubing 98 is submersed in the hot water for a retention time of at least about 5 seconds, i.e., for a time period in order to bring the film up to the desired temperature, following which supplemental heating means (not illustrated) including a plurality of steam rolls around which irradiated tubing 98 is partially wound, and optional hot air blowers, elevate the temperature of irradiated tubing 98 to a desired orientation temperature of from about 240° F. to about 250° F. Thereafter, irradiated film 98 is directed through nip rolls 106, and bubble 108 is blown, thereby transversely stretching irradiated tubing 98. Furthermore, while being blown, i.e., transversely stretched, irradiated film 98 is drawn (i.e., in the longitudinal direction) between nip rolls 106 and nip rolls 114, as nip rolls 114 have a higher surface speed than the surface speed of nip rolls 106. As a result of the transverse stretching and longitudinal drawing, irradiated, biaxially-oriented, blown tubing film 110 is produced, this blown tubing preferably having been both stretched at a ratio of from about 1:1.5-1:6, and drawn at a ratio of from about 1:1.5-1:6. More preferably, the stretching and drawing are each performed at a ratio of from about 1:2-1:4. The result is a biaxial orientation of from about 1:2.25-1:36, more preferably, 1:4-1:16.

While bubble 108 is maintained between pinch rolls 106 and 114, blown tubing 110 is collapsed by rolls 112, and thereafter conveyed through nip rolls 114 and across guide roll 116, and then rolled onto wind-up roll 118. Idler roll 120 assures a good wind-up.

FIG. 4 illustrates a schematic view of a process for making a non-heat shrinkable film, i.e., a “hot-blown” film, which is oriented in the melt state and is not heat shrinkable. Although only one extruder 139 is illustrated in FIG. 4, there can be more extruders, such as 2 or 3 extruders. Extruder 130 supplies molten polymer to annular die 131 for the formation of the film, which can be monolayer or multilayer, depending upon the design of the die and the arrangement of the extruder(s) relative to the die, as known to those of skill in the art. Extruder 130 is supplied with polymer pellets suitable for the formation of the film. Extruder 130 subjects the polymer pellets to sufficient heat and pressure to melt the polymer and forward the molten stream through die 131. Although only one extruder is illustrated, it is understood that more than one extruder can be utilized to make the films.

Extruder 130 is equipped with screen pack 132, breaker plate 133, and heaters 134. The film is extruded between mandrel 135 and die 131, with the resulting extrudate being cooled by cool air from air ring 136. The molten extrudate is immediately blown into blown bubble 137, forming a melt oriented film. The melt oriented film cools and solidifies as it is forwarded upward along the length of bubble 137. After solidification, the film tubing passes through guide rolls 138 and is collapsed into lay-flat configuration by nip rolls 139. The collapsed film tubing is optionally passed over treater bar 140, and thereafter over idler rolls 141, then around dancer roll 142 which imparts tension control to collapsed film tubing 143, after which the collapsed film tubing is wound up as roll 144 via winder 145.

To aid in flow and miscibility, having the smaller phase domaine size of polyamide and/or EVOH is beneficial. In embodiments, the compatibilizer and rheological modifier reduce the polyamide domaine size. In embodiments, the average polyamide fibril domaine size in a layer of film is less than 5 microns in the machine direction. In embodiments, the average polyamide fibrils size is less than 2 microns in the polymeric mixture. Without the addition of the compatibilizers and rheology modifiers described herein, fibril domaine size in a layer of film is more than 5 microns and up to 10 microns. These longer fibrils hinder flow and miscibility of the polymers.

The multilayer film may further include at least one barrier layer. As used herein, the term “barrier”, and the phrase “barrier layer”, as applied to films and/or film layers, are used with reference to the ability of a film or film layer to serve as a barrier to one or more gases. Oxygen transmission rate is one method to quantify the effect of a barrier layer. In embodiments the multilayer film structure has an oxygen transmission rate of at least 10,000, 9000, 8000, 7000, 6000, 5000 4000, 3000, 2000 or 1000 cubic centimeters (at standard temperature and pressure) per square meter per day per 1 atmosphere of oxygen pressure differential measured at 0% relative humidity and 23° C. measured according to ASTM D-3985. As used herein, the term “oxygen transmission rate” refers to the oxygen transmitted through a film in accordance with ASTM D3985 “Standard Test Method for Oxygen Gas Transmission Rate Through Plastic Film and Sheeting Using a Coulometric Sensor,” which is hereby incorporated, in its entirety, by reference thereto.

Useful barrier polymers include vinylidene chloride polymers (“PVdC”), ethylene/vinyl alcohol copolymers (“EVOH”), polyvinyl alcohol copolymers (“PVOH”), high amylose starches, polyesters and/or polyamides.

In embodiments, the film is used for protective product packaging. In another embodiment, the film is used for food packaging. The resulting film can be used to form bags, casings, thermoformed articles and lidstocks therefor, etc., which, in turn, can be used for the packaging of food-containing products. While various embodiments are described herein, other packaging structures, such as end-seal bag, side-seal bag, L-seal bag, U-seal pouch, gusseted pouch, lap-sealed form-fill-and-seal pouch, fin-sealed form-fill-and-seal pouch, stand-up pouch, casing and the like are contemplated.

The film may have a gloss (i.e., specular gloss) as measured against the outside layer of at least about, and/or at most about, any of the following values: 40%, 50%, 60%, 63%, 65%, 70%, 75%, 80%, 85%, 90%, and 95%. These percentages represent the ratio of light reflected from the sample to the original amount of light striking the sample at the designated angle. All references to “gloss” values in this application are in accordance with ASTM D 2457 (45° angle), which is incorporated herein in its entirety by reference.

Haze is a measurement of the transmitted light scattered more than 2.5° from the axis of the incident light. Haze is measured against the outside surface of the film according to the method of ASTM D 1003, which is incorporated herein in its entirety by reference. All references to “haze” values in this application are by this standard. The haze of the film may be not higher than any of the following values: 20%, 15%, 10%, 9%, 8%, 7%, 6%, 5%, 4%, 3%, and 1%. Any of the first and/or second films may have any of these haze values after a representative sample of the film is placed for two hours in a conventional oven having an air temperature of 204.4° C.

The first and/or second films may be transparent (at least in the non-printed regions) so that the packaged article is visible through the film. “Transparent” as used herein means that the material transmits incident light with negligible scattering and little absorption, enabling objects (e.g., packaged food or print) to be seen clearly through the material under typical unaided viewing conditions (i.e., the expected use conditions of the material). The transparency (i.e., clarity) of the film may be at least any of the following values: 20%, 25%, 30%, 40%, 50%, 65%, 70%, 75%, 80%, 85%, and 95%, as measured in accordance with ASTM D1746. All references to “transparency” values in this application are by this standard.

The film may be oriented in either the machine (i.e., longitudinal), the transverse direction, or in both directions (i.e., biaxially oriented), for example, to enhance the strength, optics, and durability of the film. A web or tube of the film may be uniaxially or biaxially oriented by imposing a draw force at a temperature where the film is softened (e.g., above the vicat softening point; see ASTM 1525) but at a temperature below the film's melting point. The film may then be quickly cooled to retain the physical properties generated during orientation and to provide a heat-shrink characteristic to the film. The film may be oriented using, for example, a tenter-frame process or a bubble process (double bubble, triple bubble and likewise). These processes are known to those of skill in the art, and therefore are not discussed in detail here. The orientation may occur in at least one direction by at least about, and/or at most about, any of the following ratios: 1.5:1, 2:1, 2.5:1, 3:1, 3.5:1 , 4:1, 5:1, 6:1, 7:1, 8:1, 9:1, 10:1, 12:1, and 15:1.

The film may have a heat-shrinkable attribute. For example, the film may have a free shrink in at least one direction (i.e., machine or transverse direction) or in at least each of two directions (machine and transverse directions) measured at 104.4° C. of at least any of the following: 3%, 7%, 10%, 15%, 20%, 25%, 30%, 40%, 50%, 55%, 60%, and 65%. Further, the films may have any of a free shrink in at least one direction (machine or transverse direction) or in at least each of two directions (machine and transverse directions) of at least any of these listed shrink values when measured at any of 37.8° C., 48.9° C., 60.0° C., 71.1° C., 85.0° C., 87.8° C., 93.3° C., and 98.9° C. Unless otherwise indicated, each reference to free shrink in this application means a free shrink determined by measuring the percent dimensional change in a 10 cm×10 cm specimen when subjected to selected heat (i.e., at a certain temperature exposure) according to ASTM D-2732.

In embodiments the multilayer film is partially or wholly cross-linked. To produce cross-linking a film, layer or layers of the film are treated with a suitable radiation dosage of high-energy electrons. In embodiments an electron accelerator introduces the radiation dosage, with a dosage level being determined by standard dosimetry methods. It is understood that other accelerators, such as a Van der Graaf generator or resonating transformer may be used. The radiation is not limited to electrons from an accelerator since any ionizing radiation may be used. In embodiments the radiation dosage of high energy electrons is up to 140 kGrays, in the range of from 10 to 120 kGrays, in the range of from 20 to 100, or in the range of from 30 to 80 kGrays. In an embodiment irradiation is performed prior to orientation. In an embodiment irradiation is performed after orientation.

### EXAMPLES

Four monolayer films were made and tested. The results are reported herein.

Polymer blend is a polymer blend created from scrap and reclaimed materials consisting of 30% polyethylene, 28% polyamide, 10% ethylene vinyl alcohol, 12% polypropylene, 15% malic anhydride grafted polyethylene and 5% ethylene vinyl acetate. Because of the variability of reclaimed material concentration, polymer blends may range in concentration my having up to 30% polypropylene, up to 30 wt % polyamide, up to 15 wt % ethylene vinyl alcohol, up to 15 wt % malic anhydride grafted polyethylene, up to 22 wt % ethylene vinyl acetate and between 24 and 40 wt % polyethylene. The blend was pelletized and served as the majority component in Films 1-4. Film 1 being 100% of the Polymer blend. In the instance of Films 2-4, Polymer blend was mixed with additives, and then extruded into monolayer film structures.

TABLE 1

| | | | Extensibility Index = |
|---|---|---|---|
| | | | ratio of winder speed |
| | | | (ft/min) to extruder |
| | Additive 1 | Additive 2 | speed (rpm) |
| Film 1 | | Control blend | 2.27 |
| Film 2 | 5% olefin | | 2.86 |
| | block | | |
| | copolymer | | |
| | (Intune ™) as | | |
| | a pellet blend | | |
| Film 3 | 5% olefin | 5% Ethylene acrylic | 3.4 (very good draw- |
| | block | acid (AC ® 540) | down) |
| | copolymer | | |
| | (Intune ™) | | |
| | compounded | | |
| Film 4 | 5% functional | | 0.87 (very poor |
| | compatibilizer | | extensibility) |
| | (Retain ™ 3000) | | |

As shown in Table 1, Film 3 exhibited a higher extensibility index, which is desirable for extrusion processing.

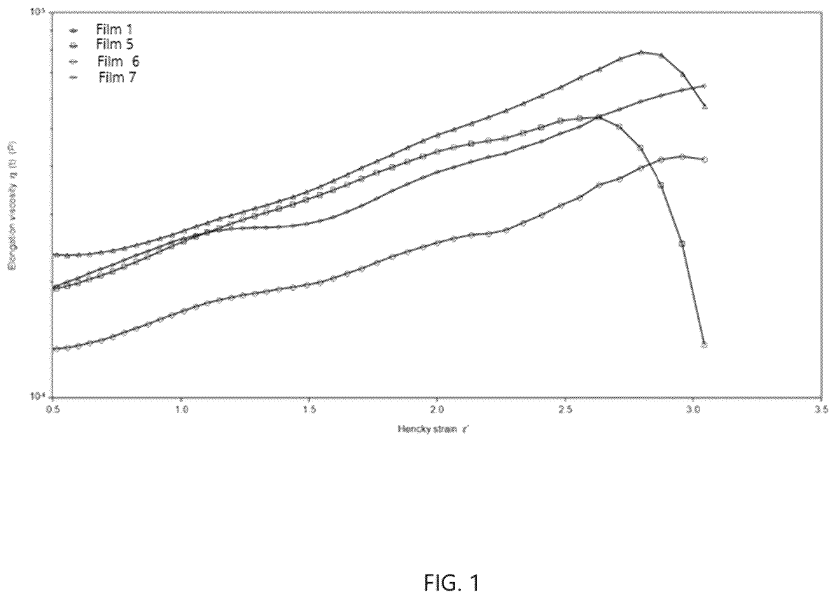

Turning now to FIG. 1, three additional films where made to demonstrate the improved elongation viscosity-strain curve by combining a compatibilizer with a rheology modifier. The monolayer films were made as stated above with the following formulations. Films 5-7 included the Polymer blend mixed with the additives and then extruded into monolayer film structures.

| | Additive 1 | Additive 2 | Additive 3 |
|---|---|---|---|
| Film 1 | | | |
| Film 5 | 1% Antioxidant | | |
| Film 6 | 1% Antioxidant | 5% Ethylene acrylic | |
| | | acid (AC ® 540) | |
| Film 7 | 1% Antioxidant | 5% Ethylene acrylic | 5% olefin block |
| | | acid (AC ® 540) | copolymer (Intune ™) |
| | | | compounded |

Data from elongation viscosity measurements of the various blends are shown in FIG. 1. Film 1 does not flow well and its elongational viscosity increases with the strain, indicating strain hardening. An abrupt dip in the elongation viscosity curve indicates film break. Upon addition of 1% antioxidant (Film 5), the elongation viscosity of the blend is lowered significantly indicative of poor melt strength. As shown in Film 6, the addition of 5% low molecular weight ethylene acrylic acid significantly lowers the elongation viscosity. However, the improvement in flow comes at the cost of poor melt strength. As shown in working example of Film 7 an improvement in elongation viscosity and the film does not break even at the highest Henke strain.

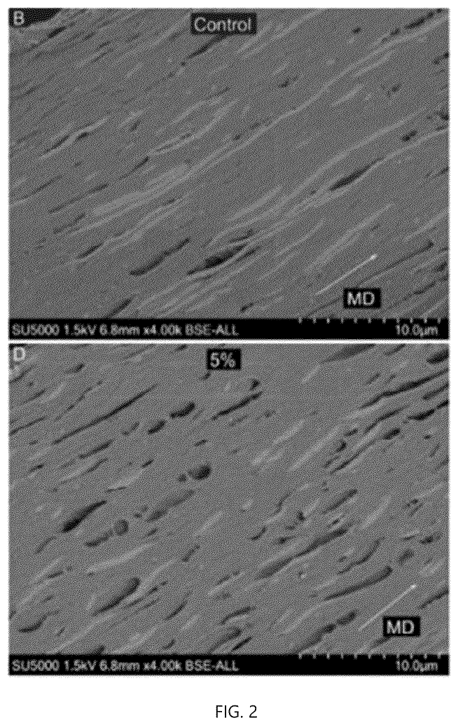

Turning now to FIG. 2, Film 1 (labeled as control shows long fibril domaine size, whereas the film including compatibilizer with a rheology modifier showed smaller fibril domaine sizes which will aid in flow and processability. The images of FIG. 2 are gathered by the films being microtomed along machine directions to image the domain cross-sections via SEM.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A method for forming polymeric pellets comprising the steps of:
i. heating a blended polymer mixture comprising a polyolefin, polyamide, an anhydride grafted polymer and polypropylene to the melting or glass transition temperature of the polymers included in the blended polymer mixture to form a polymer blend;
ii. mixing a compatibilizer and a rheology modifier with the polymer blend to form a polymeric mixture;
iii. cooling the polymeric mixture to form a solidified polymeric mixture; and
iv. pelletizing the solidified polymeric mixture to form polymeric pellets; the polymeric pellets comprising a polyolefin, polyamide, an anhydride grafted polymer, polypropylene a compatibilizer and a rheology modifier.

2. The method of claim 1 wherein the blended polymer mixture further comprises ethylene vinyl alcohol and/or ethylene vinyl acetate.

3. The method of claim 1 wherein the compatibilizer is present in the polymeric pellets in an amount of 1-10 wt %.

4. The method of claim 1 wherein the rheology modifier is present in the polymeric pellets in an amount of 1-10 wt %.

5. The method of claim 1 wherein the anhydride grafted polymer is an anhydride grafted polyethylene, anhydride grafted polypropylene or blend thereof and is present in the polymeric pellets in an amount of 5-20 wt %.

6. The method of any of claim 5 wherein the anhydride grafted polymer is a malic anhydride grafted polyethylene, malic anhydride grafted polypropylene or blend thereof.

7. (canceled)

8. The method of claim 1 wherein the compatibilizer is a block polypropylene/polyethylene copolymer.

9. (canceled)

10. The method of claim 1 wherein the rheology modifier is a low molecular weight ethylene acrylic acid or a low molecular weight ethylene methacrylic acid copolymer.

11. The method of claim 1 wherein the rheology modifier is an ionomer.

12. (canceled)

13. The method of claim 1 wherein the polymeric pellets comprise 5-40 wt % ethylene/alpha-olefin copolymer, 5-40 wt % polyamide and 5-40 wt % polypropylene.

14. The method of claim 1 wherein the polymeric pellets comprise 5-25 wt % ethylene vinyl alcohol and less than 10 wt % ethylene vinyl acetate.

15. The method of claim 1 wherein the polymeric pellets comprise 5-20 wt % anhydride grafted polymer.

16. The method of claim 1 wherein the polymeric pellet comprises less than 50 wt % of polyolefins and 10-40 wt % polyamide.

17. (canceled)

18. The method of claim 1 wherein no single polymer comprises more than 50 wt % of the polymer blend.

19. (canceled)

20. (canceled)

21. The method of claim 1 wherein the polymeric pellets comprise 20-40 wt % polyolefin, 20-35 wt % polyamide, 10-20 wt % anhydride grafted polymer, 5-15 wt % ethylene vinyl alcohol, 5-15 wt % polypropylene and less than 10 wt % ethylene vinyl acetate.

22. The method of claim 1 further comprising the step of mixing less than 50 wt % virgin polymer with the polymer blend.

23. (canceled)

24. The method of claim 1 further comprising adding between 0.05 and 3 wt % of an antioxidant to the polymeric mixture.

25. The method of claim 1 wherein the polymeric mixture has a density between 0.8 g/cm³ and 1.2 g/cm³, 0.9 g/cm³ and 1.1 g/cm³, or 0.9 g/cm³ and 1.05 g/cm³as measured according to ASTM D-1505.

26-49. (canceled)

50. A polymeric pellet comprising:
a. a polyolefin;
b. a polyamide;
c. an anhydride grafted polymer;
d. a polypropylene;
e. a compatibilizer; and
f. a rheology modifier.

51-68. (canceled)

69. A multilayer film comprising at least one layer comprising:
a. a polyolefin;
b. a polyamide;
c. an anhydride grafted polymer;
d. a polypropylene;
e. a compatibilizer; and
f. a rheology modifier.

70-87. (canceled)
